(19) United States
(12) Patent Application Publication
(10) Pub. No.: US 2021/0376883 A1
(43) Pub. Date: Dec. 2, 2021

(54) BLUETOOTH ATTACHMENT TO IN-FLIGHT ENTERTAINMENT SYSTEMS THAT MAINTAIN EXISTING FUNCTIONALITY

(71) Applicants: Logan Gregory Harper, Marina Del Rey, CA (US); Colby Curtis Harper, Park City, UT (US)

(72) Inventors: Logan Gregory Harper, Marina Del Rey, CA (US); Colby Curtis Harper, Park City, UT (US)

(21) Appl. No.: 16/889,517

(22) Filed: Jun. 1, 2020

(51) Int. Cl. H04B 5/02; H04R 3/00; B64D 11/00; H04W 4/80; H04W 4/30

(52) U.S. Cl. CPC H04B 5/02; H04R 3/00; H04R 2420/07; H04W 4/80; H04W 4/30; B64D 11/00155

(57) ABSTRACT

A device that adds wireless Bluetooth capability for audio to an existing in-flight entertainment system is disclosed. Audio and power are sent from the existing system to provide power and audio input to the Bluetooth transmitter. The audio and power are split so that they are also sent to female audio and power ports for passengers to use in the same way in-flight entertainment systems are currently designed.

### TECHNICAL FIELD

The embodiments provided herein relate to near-frequency communication systems and more specifically to near-frequency communication systems which digitally encode audio and wirelessly transmit the sound over short distances to wireless audio devices.

### BACKGROUND

The wireless headphone market is growing quickly due to advancements, such as Bluetooth, infrared, and W-Fi. A number of start-ups and well-established companies, such as Apple, Samsung Electronics, Bose Corporation, and Sony Corporation, are focusing on developing innovative products. This is further expected to boost the demand for wireless products. Wired headphones currently hold 59% of the total headphone market share, with the other 41% corresponding to wireless headphones. However, this balance is expected to shift to the side of the wireless headphone segment by 2020. Since 2014, the wireless segment of headphones has outgrown the wired segment significantly. In 2017, the revenue for sales of wireless headphones corresponded to $850 million, in contrast to the $120 million of revenue for the wired headphone segment. Bluetooth audio device shipments are expected to grow at a 7% Compound Annual Growth Rate from 2018-2023, resulting in 1.27 billion devices shipped in 2023.

Existing technology in this field includes portable wireless headphone adaptors, like the AirFly. These options are battery powered (16 hours of battery life) and connect through the auxiliary port. The cost and inconvenience of the device has led to a low adoption rate in the market by the passengers. Airlines have not incorporated these devices into their entertainment system because i) the device is battery powered and would need to be removed and charged by the airline every 16 hours ii) if removable for charging purposes, the device could easily be stolen by passengers and iii) to use a device like AirFly you must plug in a 3.5 mm audio plug into the 3.5 mm audio jack on the entertainment system to provide the audio output to the Bluetooth transmitter, and once you have done that you can no longer access the audio through any other means, removing the ability to listen to the system with a wired device entirely.

No current inflight entertainment systems offer built-in Bluetooth. It is expensive for the airlines to replace entertainment systems, costing approximately $6,000 in maintenance per seat to make the change. A simple add-on to the current systems would be an optimal transition to the Bluetooth age of audio.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein disclose to an addition to in-flight entertainment system consoles that add wireless near-frequency communication capability for audio, while maintaining all previous functionality. The design of the unit would contain male and female power connectors (such as USB), male and female audio connectors, and a Bluetooth transmitter with optional UI, all connected and contained in a single enclosure. The enclosure could have a flat back to be firmly applied with adhesive onto the entertainment system. A curved design on the sides and front of the unit can minimize friction from any external contact. The unit inserts into the existing audio and power ports (such as USB) simultaneously, powering the Bluetooth transmitter without the need for batteries or external charging. The power is split and sent to a female power connector (USB) that passengers can access. The audio is split between the port and the Bluetooth transmitter, and sent to a 3.5 mm audio jack that the passengers have access to. This way if the passenger does not have a wireless listening device, they can still plug into the entertainment system audio jack with a wired connection. The audio input is sent to the Bluetooth transmitter through the audio port and can then be sent to a paired device.

In one aspect, a wireless communication system is disclosed, comprising at least one wireless audio device for transmitting and receiving audio signals. At least one console is in wireless communication with the wireless audio device via a near-frequency communication protocol. The at least one console comprises a user interface, a male and female power connector, and a near-frequency communication transmitter to transmit the audio signal to the at least one wireless audio device to maintain functionality of one or more entertainment systems.

In one aspect, the male power connector is insertable into the female power connector and a male audio connector into the female audio connector on the one or more entertainment systems.

In one aspect, the male power connector and the female power connector provide an interface for transmitting power.

In one aspect, the male power connector is insertable into the Bluetooth transmitter.

In one aspect, the near-frequency transmitter utilizes power and audio from one or more entertainment systems to provide an audio connection to the at least one wireless audio device.

In one aspect, the user interface provides a means for a user to provide at least one input to the at least one console.

In one aspect, the at least one input is a volume setting.

In one aspect, the at least one input is an operational setting.

In one aspect, the at least one input is a source setting.

The result is the ability to pair wireless headphones or earbuds such as Bose or Apple products to the in-flight entertainment system console, while maintaining all of the built-in functionality of the entertainment console.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the near-frequency communication systems, according to some embodiments;

FIG. 2 illustrates a block diagram of the system components, according to some embodiments;

FIG. 3 illustrates a perspective view of the housing of the near frequency communication console, according to some embodiments;

FIG. 4 illustrates a front elevation view of the housing of the near frequency communication console, according to some embodiments;

FIG. 5 illustrates a cross-sectional view of the housing, according to some embodiments;

FIG. 6 illustrates a top plane view of the housing of the near frequency communication console, according to some embodiments;

FIG. 7 illustrates a cross-sectional view of the housing, according to some embodiments;

FIG. 8 illustrates a rear view of the housing of the near frequency communication console, according to some embodiments;

FIG. 9 illustrates a cross-sectional view of the housing of the near frequency communication console, according to some embodiments;

FIG. 10 illustrates a left side elevation view of the housing of the near frequency communication console, according to some embodiments; and

FIG. 11 illustrates a right side elevation view of the housing of the near frequency communication console, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

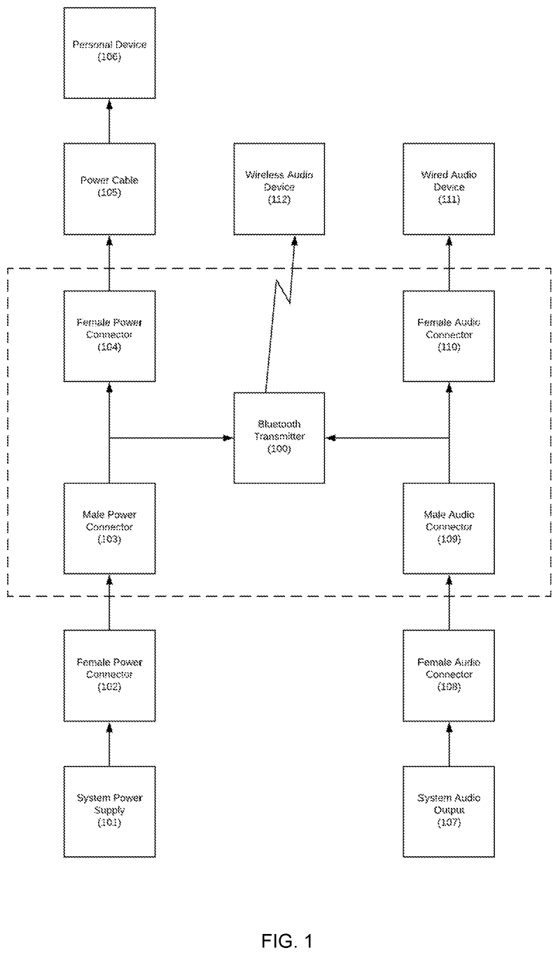

FIG. 1 is a block diagram of one embodiment that depicts how the internal components that make up the presented design connect to external components such as the inflight entertainment system and passenger provided components. The distinction of internal and external components is made by the dashed box. Everything within the dashed box is part of the system provided by the various embodiments herein, while everything outside of the dashed box may consist of external components. Each one of these components is connected to one another, either directly or via an intermediate component. These connections are illustrated in FIG. 1 as lines located between the components and may represent wired or wireless connections.

A wireless audio device and system thereof may comprise both a wireless audio device (e.g., a wireless headset, speaker and the like) and a wireless transceiver which converts wired audio signals to wireless. Generally, the wireless transceiver must adapt the wireless audio device to the specific operating requirements of a particular audio system. One embodiment of the wireless headset system comprises a single wireless audio device which can be coupled with different wireless transceivers to support a variety of audio installations.

Using the systems and methods contemplated herein, passengers in an aircraft or other vehicle are able to choose whether to connect audio devices wirelessly, via Bluetooth or other commercially suitable protocol for example, and/or via a wired audio jack. Thus, both the wireless and wired audio outputs can function at the same time if desired because the system creates parallel wireless and analog wired audio outputs. The wireless transmitter preferably is configured to communicatively couple with wireless headphones or other devices for transmission of audio information to the wireless device. Although the below discussion focuses on the use of the Bluetooth protocol for wireless transmission of the audio information, any commercially suitable protocol could be used.

Because of the sheer number of wireless transmitters that may be in use within an aircraft or other vehicle, the inventive subject matter contemplates various systems and methods to reduce the risk of interference of the various transmitters from impacting passengers' quality of service of the vehicle entertainment system.

To reduce the risk of interference, it is contemplated that the audio output device can adjust a transmission power of the wireless transmitter of the audio output device as a function of a measured received signal strength indicator (RSSI) level of a connected slave device (e.g., wireless headphones) and a transmission power of the connected slave device.

The audio output device preferably also includes a push button or other actuator, which could be digital, that permits pairing and unpairing of a wireless device such as wireless headphones for example. Importantly, pairing or unpairing of the wireless device does not affect (e.g., turn on or off) audio output via the wired audio output(s).

In FIG. 1 the embodiment illustrated is one where the present disclosure is receiving both power supply 101 and audio output 107 from an inflight entertainment system. In this depiction, power is supplied to the device via corresponding male power connector 103 and female power connector 102. These can be any connector that transfers power such as a USB, micro USB, 3-prong power connector, etc. For example, if the female power connector 102 provided on the airplane's entertainment system is a standard USB receptacle, then the embodiment of the device for this instance would include a standard USB plug as its male power connector 103. From the male power connector 103, the power is sent to the Bluetooth transmitter 100 in the device via a conductor (e.g., a wire). This allows the Bluetooth transmitter and any components that may be included in it to be continuously powered without need of batteries or intermittent charging. However, the conductor used to send power from the male power connector 103 to the Bluetooth transmitter 100 is split, and also sent to a female power connector 104. This female power connector 104 is within the device and if desired can mimic the female power connector 102 provided from the inflight entertainment system. This allows a user to connect a power cable 105 to the device and provide power (such as charge) to their personal device 106.

In the example depicted in FIG. 1, output audio 107 is supplied to the device via corresponding male audio connector 109 and female audio connector 108. The female audio connector 108 provided by the inflight entertainment system can be any port that transfers audio signal but is most commonly a 3.5 mm audio jack. In that scenario, the male audio connector 109 in this embodiment would be a 3.5 mm audio aux. From the male audio connector 109, the audio signal is sent to the Bluetooth transmitter 100 in the device via a conductor (e.g., a wire). This allows the Bluetooth transmitter to directly receive the system audio output 207. If a passenger has a wireless audio device 112, the Bluetooth transmitter 100 can wirelessly send the audio signal to that device. However, the conductor used to send audio from the male audio connector 109 to the Bluetooth transmitter 100 is split, and also sent to a female audio connector 110. This female audio connector 110 can mimic the female audio connector 109 provided from the inflight entertainment system, but is not limited to doing so. This female audio connector 110 within the device will allow a user to connect a wired audio device 111 and receive the system audio output 107.

In some embodiments, the connector has at least one terminal that is in contact to receive a power supply voltage from a power supply voltage source associated with the audio source. The transmission apparatus receives the power supply voltage and conditions the power supply voltage for providing energy for performing the method for wireless in-flight entertainment distribution.

In some embodiments, the wireless in-flight entertainment distribution further receives the transmission signal from the transmission media. The transmission signal is then demodulated, depacketized, and decoded to recover the audio signal. The recovered audio signal is then transmitted to the paired device.

This embodiment of the design depicted in FIG. 1 illustrates how all existing functionality provided by an inflight entertainment system can be maintained while adding a permanent solution for a wireless audio experience. While the Bluetooth transmitter requires both the system power supply 101 and the system audio output 107, it does not restrict their access by a user. Even while the Bluetooth transmitter 100 is utilizing both the system power supply 101 and the system audio output 107, a passenger will still have access to both via the originally designed means through the device's female power connector 104 and female audio connector 110.

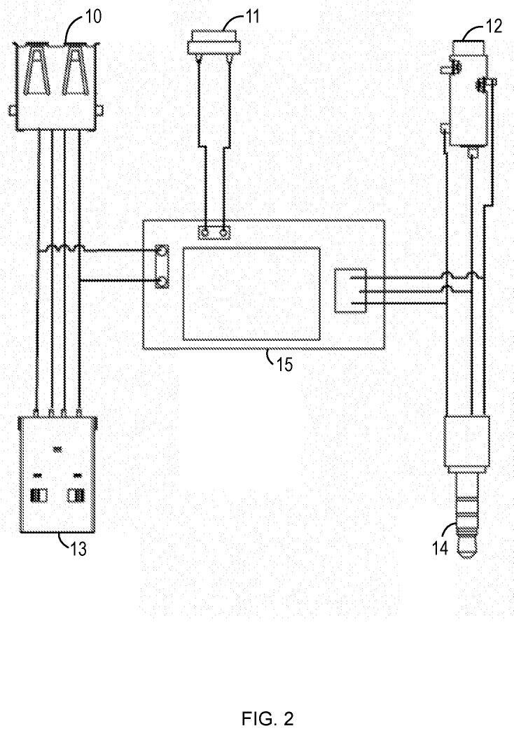

FIG. 2 further depicts the components and their connections for one example of the disclosed device. In the example illustrated, a USB plug 13 is used to receive power from the inflight entertainment system, though the present disclosure is not limited to only using a USB plug to receive power, as for example a 3-prong power plug could be used if needed. The Vbus (+5 V), Data−, Data+, and Ground pins of the USB plug 13 are soldered or otherwise connected to individual conductors such as wires. These conductors connect to the corresponding pins on a USB receptacle 10 in this embodiment, though the customer facing power connector is not limited to a USB receptacle, but can be any receptacle that provides power. Passengers have access to this USB receptacle 10 and can use it to charge their personal devices as long as they have the appropriate cable. Between the USB plug 13 and the USB receptacle 10, the conductors connected to the Vbus and Ground pins are split, and two additional conductors create a connection from the USB plug 13 to the Bluetooth transmitter 15. This connection provides consistent power to the Bluetooth transmitter. This method is just one example of a possible solution to providing power to the Bluetooth transmitter. It is also possible for example, to split all 4 conductors and utilize a micro USB connection to provide power to the Bluetooth transmitter. Any method that provides power to the Bluetooth transmitter from the USB receptacle 10 can be applied to the present disclosure.

In some embodiments, a battery can be included in the Bluetooth transmitter 15 to provide extra life in the event that the system power supply is not available, though this is not a requirement. In some embodiments the power circuitry may be configured to be wired in a multiple-way circuit based on the needs of the system. In some embodiments, the Bluetooth transmitter 15 can include a user interface 11 for capturing user input and or providing user feedback. User interface may include a switch SW, which may be mechanical or any other type of switch, a capacitive or otherwise touch sensitive interface TCH, a display DSP, or the like. If a display is used it may be as simple or as complex as desired. For example, the display may be an indicator LED, multiple indicator LEDs, an LED array, a full display such as a liquid crystal display (LCD), or any combination thereof.

User input can be used for any functionality existing Bluetooth transmitters provide such as powering on/off, enabling or disabling pairing, etc. In some embodiments, an indicator such as an LED or an LCD may be separated from the user interface, such as an LED that is positioned near a user interface such as a button.

FIG. 2 also depicts a 3.5 mm audio jack 14 as being used for the male audio connector to receive the audio output from the inflight entertainment system. In the depiction, 3 conductors are connected to the audio jack 14 and extend the connection to a 3.5 mm audio port 12. While 3 conductors are illustrated in FIG. 2, more or less could be used in a working design of the presented disclosure. The 3.5 mm audio port 12 is accessible to the passengers and can be used to listen to the inflight entertainment system audio by connecting a wired device to the audio port 12.

Between the 3.5 mm audio jack 14 and the 3.5 mm audio port 12, the conductors that provide the connection are split in order to send the same audio signal simultaneously to the Bluetooth transmitter 15. This allows the Bluetooth transmitter 15 to transmit the inflight entertainment system audio to a passenger's connected wireless device. A USB plug 13 and USB receptacle 10 provide means for connecting to the console, or to a third-party device.

FIG. 3 depicts an example of the presented disclosure if the components outlined in FIG. 2 are to be encased in a single enclosure to be used in a commercial setting. The USB plug 13 and the 3.5 mm audio jack 14 protrude from the enclosure so that they can be inserted in the ports of the inflight entertainment system. The USB receptacle 10, 3.5 mm audio port 12, and user interface 11 are exposed and accessible to the passenger.

While the inserted USB plug 13 and 3.5 mm audio jack 14 will keep the device in place, additional support can be added to ensure that the device is not removed or tampered with.

For example, adhesive could be added to the enclosure wherever contact with the inflight entertainment system is made. With the adhesive connecting the enclosure and the inflight system, it would add extra security to the implementation.

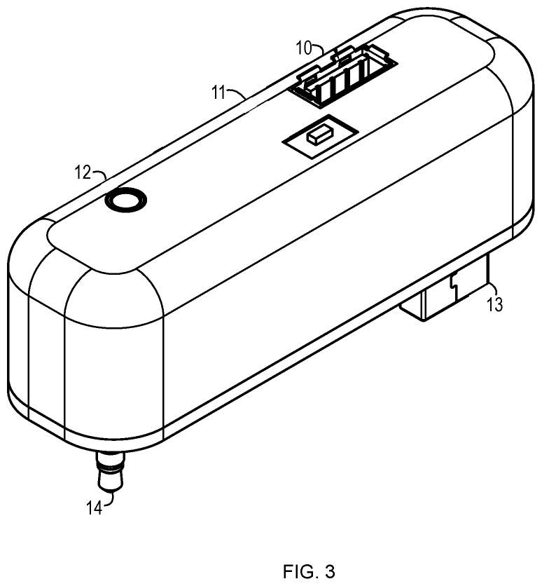

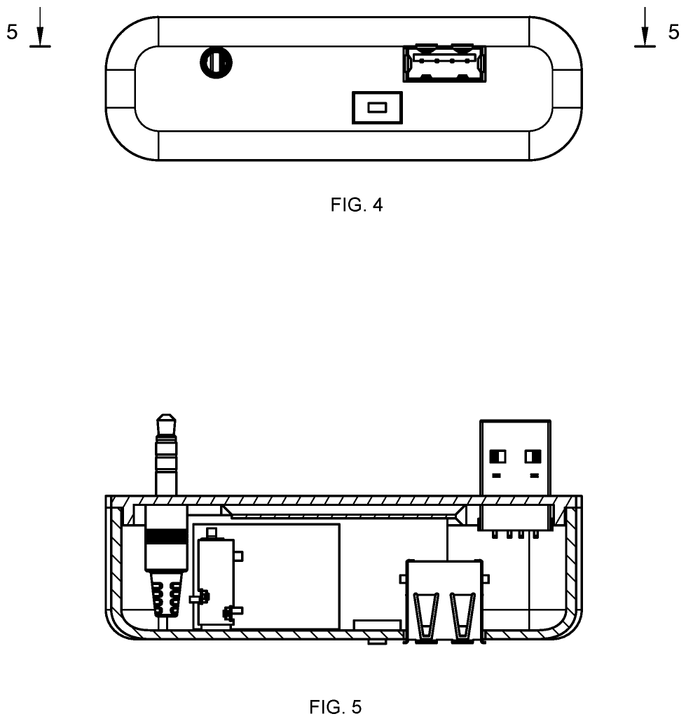

FIG. 4 illustrates a front elevation view of the housing of the near frequency communication console providing one or more input ports for connectivity to various devices.

FIG. 5 illustrates a cross-sectional view of the housing to illustrate the internal components thereof.

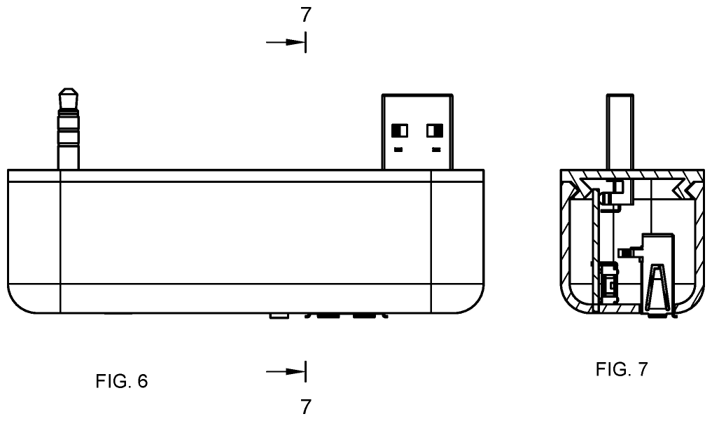

FIG. 6 illustrates a top plan view of the housing of the near frequency communication console including the USB input and auxiliary input features.

FIG. 7 illustrates a cross-sectional view of the housing to illustrate the internal components thereof.

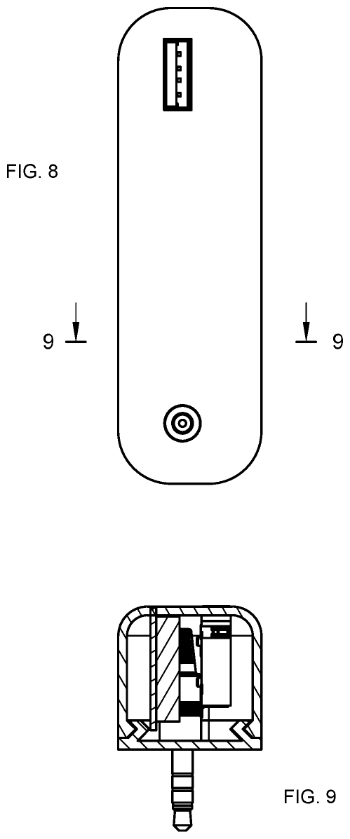

FIG. 8 illustrates a rear view of the housing of the near frequency communication console to illustrate the USB and auxiliary inputs provided on the rear-side of the housing. FIG. 9 illustrates a cross-sectional view of the housing of the near frequency communication console to illustrate the internal components thereof.

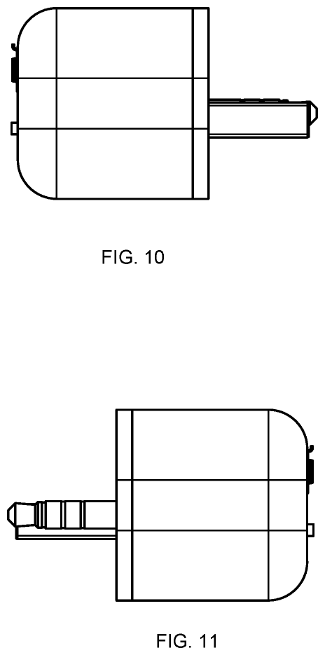

FIG. 10 illustrates a left side elevation view of the housing of the near frequency communication console. Similarly, FIG. 11 illustrates a right-side elevation view of the housing of the near frequency communication console.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a sub combination.

It will be appreciated by persons skilled in the art that the present embodiment is not limited to what has been particularly shown and described herein above. A variety of modifications and variations are possible in light of the above teachings without departing from the following claims.

What is claimed is:

1. A wireless communication system, comprising:
at least one wireless audio device for transmitting and receiving audio signals;
at least one console in wireless communication with the wireless audio device via a near-frequency communication protocol, wherein the at least one console comprises a user interface, a male and female power connector, and a near-frequency communication transmitter to transmit the audio signal to the at least one wireless audio device to maintain functionality of one or more entertainment systems.

2. The system of claim 1, wherein the male power connector is insertable into the female power connector and a male audio connector is insertable into the female audio connector on the one or more entertainment systems.

3. The system of claim 2, wherein the male power connector and the female power connector provide an interface for transmitting power.

4. The system of claim 3, wherein the male power connector is connected to the Bluetooth transmitter.

5. The device of claim 4, wherein the near-frequency transmitter utilizes power and audio from one or more entertainment systems to provide an audio connection to the at least one wireless audio device.

6. The device of claim 5, wherein the user interface provides a means for a user to provide at least one input to the at least one console.

7. The device of claim 6, wherein the at least one input is a volume setting.

8. The device of claim 7, wherein the at least one input is an operational setting.

9. The device of claim 8, wherein the at least one input is a source setting.

10. A wireless communication system, comprising:
at least one wireless audio device for transmitting and receiving audio signals;
at least one console in wireless communication with the wireless audio device via a near-frequency communication protocol, wherein the at least one console comprises a user interface, a male and female power connector, and a near-frequency communication transmitter to transmit the audio signal to the at least one wireless audio device to maintain functionality of an one or more entertainment systems, wherein the at least one console is contained within a housing, wherein the female power connector is provided on an exterior surface of the housing.

11. The system of claim 10, wherein the user interface is provided on the housing.

12. The system of claim 11, wherein the male power connector is insertable into the female power connector and a male audio connector is insertable into the female audio connector on the one or more entertainment systems.

13. The system of claim 12, wherein the male power connector and the female power connector provide an interface for transmitting power.

14. The system of claim 13, wherein the male power connector is insertable into the Bluetooth transmitter.

15. The device of claim 14, wherein the near-frequency transmitter utilizes power and audio from one or more entertainment systems to provide an audio connection to the at least one wireless audio device.

16. The device of claim 15, wherein the user interface provides a means for a user to provide at least one input to the at least one console.

17. The device of claim 16, wherein the at least one input is a volume setting.

18. The device of claim 17, wherein the at least one input is an operational setting.

19. The device of claim 18, wherein the at least one input is a source setting.

20. A wireless communication system, comprising:
at least one wireless audio device for transmitting and receiving audio signals;
at least one console in wireless communication with the wireless audio device via a near-frequency communication protocol, wherein the at least one console comprises a user interface, a male and female power connector, and a near-frequency communication transmitter to transmit the audio signal to the at least one wireless audio device to maintain functionality of an one or more entertainment systems, wherein the at least one console is contained within a housing, wherein the female power connector is provided on an exterior surface of the housing, wherein the user interface is provided on the exterior of the housing, and wherein the user interface comprises at least one of the following: at least one indicator, at least one display, at least one touch-screen interface.
